(19) United States
(12) Patent Application Publication
(10) Pub. No.: US 2005/0136956 A1
(43) Pub. Date: Jun. 23, 2005

(54) Radio relay device

(76) Inventor: Hiroki Ohno, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/744,526

(22) Filed: Dec. 23, 2003

(51) Int. Cl. H04B 15/00

(52) U.S. Cl. 455/501; 455/63.1

(57) ABSTRACT

The object of the present invention is to provide a radio relay device for suppressing the deterioration of voice signals which is generated by relaying radio communication between digital radio units. To achieve this object, the radio relay device of the present invention comprises a radio section for transmitting/receiving ADPCM-coded digital radio signals, a demodulation section for demodulating the digital radio signals received by the radio section and acquiring ADPCM codes, a voice quality improvement circuit for removing the clicking noises included in the ADPCM codes which were demodulated by the demodulation section, and a modulation section for modulating the ADPCM codes after the clicking noises are removed by the voice quality improvement circuit, and supplying the modulation signals to the radio section.

### BACKGROUND OF THE INVENTION

1. Field of the Invention

The present invention relates to a radio relay device for relaying ADPCM-coded digital radio signals, and more particularly to an improvement technology for decreasing the deterioration of voice signals which occurs when radio signals are relayed.

2. Description of the Related Art

FIG. 3 shows a conventional radio relay. In FIGS. 3, 41 and 42 are digital radio units, and 43 is a radio relay device. The radio relay device 43 receives radio waves transmitted from the digital radio unit 41 via the radio space AIR-1, detects the radio waves, performs time adjustment for the transmission signals, then modulates the signals and sends them to the digital radio unit 42 again via the radio space AIR-2.

When radio waves are relayed from the digital radio unit 41 to the digital radio unit 42 in this way via the radio relay device 43, if a bit error (voice deterioration), due to fading or multi-paths, occurs to the radio space AIR-1, voice deterioration, such as a clicking noise, occurs to the digital radio unit 42, even if the communication status of the radio space AIR-2 is good.

### SUMMARY OF THE INVENTION

With the foregoing in view, it is an object of the present invention to provide a radio relay device for suppressing the deterioration of voice signals.

To solve this problem, the radio relay device of the present invention comprises a radio section for transmitting/receiving ADPCM-coded digital radio signals, a demodulation section for demodulating the digital radio signals received by the radio section and acquiring ADPCM codes, a voice quality improvement circuit for removing the clicking noises included in the ADPCM codes demodulated by the demodulation section, and a modulation section for modulating the ADPCM codes after the clicking noises are removed by the voice quality improvement circuit, and supplying the modulation signals to the radio section.

By removing the clicking noises included in the received ADPCM codes when the digital radio signals are relayed, the deterioration of the voice quality can be decreased.

It is preferable that the voice quality improvement circuit further comprise a clicking noise detection circuit which judges that clicking noises are included when a short block average value of the absolute values of the ADPCM codes exceeds a predetermined value, and a code error correction circuit for estimating a bit error position of the ADPCM codes so that the change of the short block average value of the absolute values of the ADPCM codes becomes smallest, and correcting the codes, when a transmission error is generated in the ADPCM codes which were judged as including the clicking noises.

By estimating the error pattern of the received codes so that the change of the short block average value of the absolute values of the received ADPCM codes become small, and correcting the error, the improvement of voice quality can be attempted.

As another configuration of the voice quality improvement circuit, the voice quality improvement circuit may further comprise a clicking noise detection circuit for judging that clicking noises are included when the differential value of the short block average value of the absolute values of the ADPCM codes exceeds a predetermined value, and a code correction circuit for estimating a bit error position of the ADPCM codes so that the change of the short block average value of the absolute values of the ADPCM codes become smallest, and correcting the codes, when a transmission error is generated in the ADPCM codes which were judged as including the clicking noises.

### BRIEF DESCRIPTION OF THE DRAWINGS

FIG. 1 is a block diagram depicting the circuit of the radio relay device of the present embodiment;

FIG. 2 is a block diagram depicting the voice quality improvement circuit; and

FIG. 3 is a diagram depicting a conventional radio relay device.

### DESCRIPTION OF THE PREFERRED EMBODIMENTS

Preferred embodiments of the present invention will now be described with reference to the accompanying drawings.

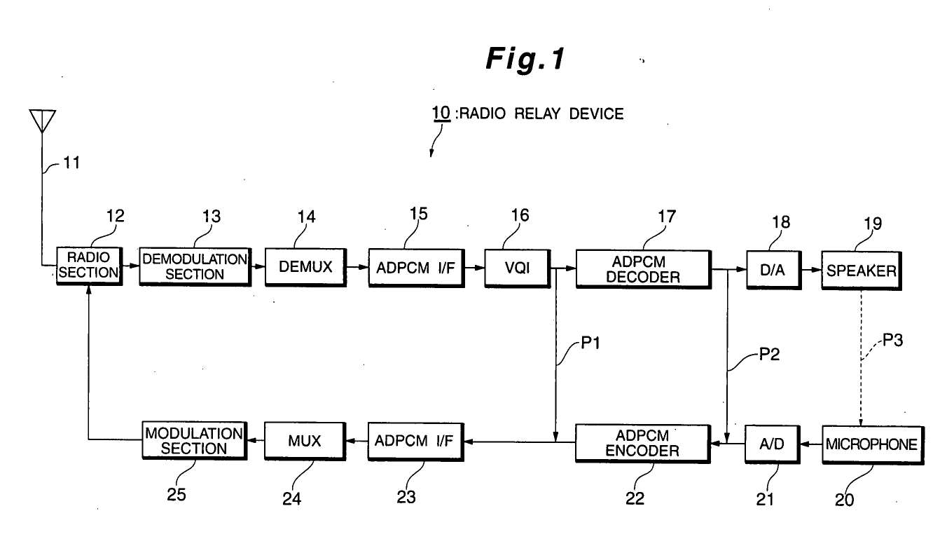

FIG. 1 is a block diagram depicting the radio relay device of the present embodiment. The radio relay device 10 is for relaying the digital radio signals which are encoded with ADPCM codes, and is comprised of an antenna 11, radio section 12, demodulator 13, demultiplexer 14, ADPCM interface 15, voice quality improvement circuit (VQI circuit) 16, ADPCM decoder 17, D/A converter 18, speaker 19, microphone 20, A/D converter 21, ADPCM encoder 22, ADPCM interface 23, multiplexer 24 and modulation section 25.

The digital radio signals which are input to the radio section 12 via the antenna 11 are demodulated by the demodulation section 13, then are separated into data for control, which is supplied to the CPU (not illustrated), and ADPCM codes which have voice information, by the demultiplexer 14. The ADPCM codes separated by the demultiplexer 14 are input to the voice quality improvement circuit 16 via the ADPCM interface 15. For the ADPCM codes supplied to the voice quality improvement circuit 16, clicking noises are decreased so as to improve the voice quality. Details on the circuit configuration of the voice quality improvement circuit 16 will be described later. The ADPCM codes which are output from the voice quality improvement circuit 16 are supplied to the ADPCM interface 23 via one of the signal paths P1, P2 and P3.

The signal path P1 is a signal path for directly supplying the output data (ADPCM codes) of the voice quality improvement circuit 16 to the ADPCM interface 23, without being input to the ADPCM decoder 17. The signal path P2 is a signal path for inputting the ADPCM codes after clicking noises are removed by the voice quality improvement circuit 16 to the ADPCM decoder 17, to be decoded into PCM codes, inputting the PCM codes to the ADPCM encoder 22 to return to ADPCM codes again, then supplying the ADPCM codes to the ADPCM interface 23. The signal path P3 is a signal path for inputting the ADPCM codes after the clicking noises are removed by the voice quality improvement circuit 16 to the ADPCM decoder 17 to be decoded into PCM codes, D/A-converting the PCM codes and outputting from the speaker 19 as voice signals, inputting the voice signals into the microphone 20, and converting the voice signals into PCM codes using the A/D converter 21, then inputting the PCM codes to the ADPCM encoder 22 to return the PCM codes to ADPCM codes again, and supplying the ADPCM codes to the ADPCM interface 23.

To the multiplexer 24, not only are ADPCM codes supplied from the ADPCM interface 23, but also data for control is supplied from the CPU, which is not illustrated, are supplied, and the data is multiplexed and then modulated by the modulation section 25. The modulated signals are supplied to the radio section 12, and transmitted as digital radio signals via the antenna 11.

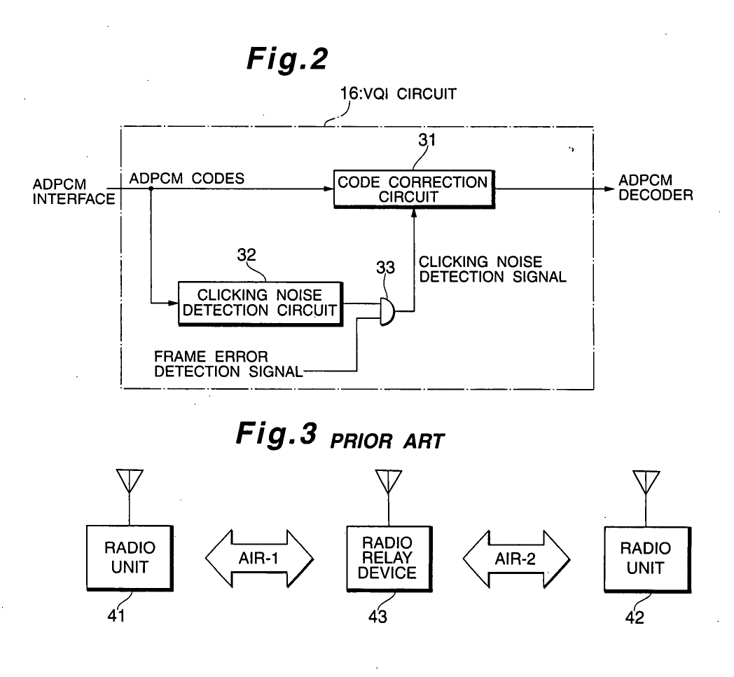

FIG. 2 shows the circuit configuration of the voice quality improvement circuit. The voice quality improvement circuit 16 is comprised of the code correction circuit 31, clicking noise detection circuit 32 and AND circuit 33. The ADPCM codes supplied from the ADPCM interface 15 to the voice quality improvement circuit 16 are input to the code correction circuit 31 and the clicking noise detection circuit 32. The clicking noise detection circuit 32 determines the short block average value of the absolute values of the ADPCM codes, and judges that clicking noises are generated when the short block average value exceeds a predetermined value. If the ADPCM code at time k is I(k) and the short block average value thereof is D(k), then D(k) can be determined by the formula (1).
D(k)=αD(k−1)+(1−α)F(I(k)) (1)

Here for I(k), the difference signal between the PCM signal and the estimate signal is converted to a logarithm of which the base is 2, this is then normalized using a scale factor, and the normalized difference signal is encoded with 4 bits according to the conversion table of a quantizer. In other words, the function F(x) is assumed to take the following values for |x|, as shown in Table 1.

| | | | | | | | | |
|---|---|---|---|---|---|---|---|---|
| \|x\| | 7 | 6 | 5 | 4 | 3 | 2 | 1 | 0 |
| F(x) | 7 | 3 | 1 | 1 | 1 | 0 | 0 | 0 |

When it is judged that clicking noises are generated in the ADPCM codes, the clicking noise detection circuit 32 outputs the signal “1” to the AND circuit 33. ADPCM codes are checked whether an error exists using a Cyclic Redundancy Check, and if an error is detected, the output of the frame error detection signal becomes “1”. Therefore if clicking noises are detected by the clicking noise detection circuit 32 and a frame error is detected by CRC, then the output signal of the AND circuit 33 becomes “1”, which is supplied to the code correction circuit 31 as a clicking noise detection signal.

When the clicking noise detection signal is received, the code correction circuit 31 estimates which of the 4 bit I(k) has an error, and corrects the code. Code error is estimated such that the change of the short block average value of the absolute values of the received codes becomes small. When the difference between D(k) and D(k−1) is determined referring to the formula (1), the formula (2) is acquired.
D(k)−D(k−1)=(1−α){F(I(k))−D(k−1)} (2)

Since (1−α) at the right hand side is a constant, the change of the short block average value of the absolute values of the received codes can be determined if the value of F(I(k))−D(k−1) is known. So dmsd(k), which is the difference information of the short block average value of the absolute values of the received codes, is defined as the formula (3).
dmsd(k)=|F(I(k))−D(k−1)| (3)

Here it is assumed that a 1 bit error occurs to the ADPCM codes. The difference information dmsd 1 (k) of the short block average value of the absolute values of the received codes when an error occurs to the least significant bit is given by the formula (4).
dmsd 1 (k)=|F(I(k)\hat{ }(0001)₂)−D(k−1)| (4)

In this description, the symbol “\hat{ }” indicates an exclusive OR, and (I(k) \hat{ }0001) is I(k) when the least significant bit thereof is inverted. In the same way, the difference information dmsd 2 (k), dmsd 3 (k) and dmsd 4 (k) of the short block average value of the absolute values of the received codes when an error occurs to the insignificant second bit, insignificant third bit (significant second bit) and insignificant fourth bit (most significant bit) are given by the formula (5) to the formula (7) respectively.
dmsd 2 (k)=|F(I(k)\hat{ }(0010)₂)−D(k−1)| (5)
dmsd 3 (k)=|F(I(k)\hat{ }(0100)₂)−D(k−1)| (6)
dmsd 4 (k)=|F(I(k)\hat{ }(1000)₂)−D(k−1)| (7)

If it is assumed that an error is one bit when an error is detected in the ADPCM codes as a result of a Cyclic Redundancy Check, the bit where the error occurs will be known by comparing each value of the formula (3)-formula (7). For example, if the value of the formula (5) is the smallest, it is known that the error occurred to the insignificant second bit. If there is no error, the value of the formula (3) is the smallest. The code correction circuit 31 estimates the error position of the bits by comparing each value of the formula (3) to the formula (7), and corrects the codes of the ADPCM codes. The ADPCM codes after code correction are supplied to the ADPCM decoder 17, and are converted into PCM codes.

In the above description, it is judged that clicking noises are generated when the short block average value D(k) of the absolute values of the ADPCM codes exceeds a predetermined value, but it may be judged that clicking noises are generated when the differential value of the short block average value of the absolute values of the ADPCM codes, that is the difference value of D(k), exceeds a predetermined value. Or both of these methods may be used.

In the above description, error correction is performed assuming that a one bit error occurred in the ADPCM codes, but the error position of the bits can be estimated in the same way as above even if it is assumed that a two bit or a three bit error occurred.

As described above, according to the radio relay 10 of the present embodiment, the error correction of the received signals can be performed by the voice quality improvement circuit 16 even when a code transmission error occurred due to fading, so the deterioration of voice signals due to passing through the radio relay device 10 can be suppressed. Also by using the radio relay device 10 of the present invention, the transmission range of a digital radio unit can be expanded.

The radio relay device 10 of the present embodiment can be implemented by simply integrating the voice quality improvement circuit 16 into a digital cordless telephone, for example, so the cost is low.

1. A radio relay device, comprising:
a radio section for transmitting/receiving ADPCM-coded digital radio signals;
a demodulation section for demodulating the digital radio signals received by said radio section and acquiring ADPCM codes;
a voice quality improvement circuit for removing the clicking noises included in the ADPCM codes demodulated by said demodulation section; and
a modulation section for modulating said ADPCM codes after clicking noises are removed by said voice quality improvement circuit, and supplying the modulation signals to said radio section.

2. The radio relay device according to claim 1, wherein said voice quality improvement circuit further comprises a clicking noise detection circuit which judges that clicking noises are included when a short block average value of the absolute values of said ADPCM codes exceeds a predetermined value, and a code error correction circuit for estimating a bit error position of said ADPCM codes so that the change of the short block average value of the absolute values of the ADPCM codes becomes smallest, and correcting the codes, when a transmission error is generated in the ADPCM codes which were judged as including said clicking noises.

3. The radio relay device according to claim 1, wherein said voice quality improvement circuit further comprises a clicking noise detection circuit which judges that clicking noises are included when a differential value of the short block average value of the absolute values of said ADPCM codes exceeds a predetermined value, and a code error correction circuit for estimating a bit error position of said ADPCM codes so that the change of the short block average value of the absolute values of the ADPCM codes becomes smallest, and correcting the codes, when a transmission error is generated in the ADPCM codes which were judged as including said clicking noises.
